(19) United States
(12) Patent Application Publication
(10) Pub. No.: US 2016/0186038 A1
(43) Pub. Date: Jun. 30, 2016

(54) Curdlan Gel Based Heat-resistant Profile Control and Water Plugging Agent

(71) Applicant: Anjieyu (Beijing) Oilfield Technical Services Co., Ltd., Beijing (CN)

(72) Inventors: Xihai Yan, Weifang (CN); Song Liu, Beijing (CN); Na Zhao, Beijing (CN); Jin Yan, Weifang (CN); Chunning Ji, Chippewa Falls, WI (US)

(73) Assignee: Anjieyu (Beijing) Oilfield Technical Services Co., Ltd., Beijing (CN)

(21) Appl. No.: 14/821,287

(22) Filed: Aug. 7, 2015

(30) Foreign Application Priority Data
Dec. 31, 2014 (CN) 201410854163.6

(51) Int. Cl. C09K 8/50

(52) U.S. Cl. CPC C09K 8/50

(57) ABSTRACT

The present invention relates to a curdlan gel based profile control and water plugging agent and methods of preparation thereof. Said profile control and water plugging agent consists of a microbial polysaccharides base and a delayed gelatinization agent; wherein said microbial polysaccharides base consists of curdlan gels and a hydrogen bond linkage force facilitation agent, or the curdlan gels and a coagulant aid. More specifically, the present invention relates to the profile control and water plugging agent that maintains its stable fluidity and relatively low viscosity under mid-to-high temperatures between 65° C. and 90° C.

### CROSS-REFERENCE TO RELATED APPLICATIONS

The present application claims priority under 35 U.S.C. §119 to Chinese patent application 201410854163.6 filed Dec. 31, 2014, the disclosure of which is incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of Invention

The present invention relates to a mid-to-high heat-resistant profile control and water plugging agent applicable on petroleum productions.

2. Background of Technology

Curdlan gel is a microbial polysaccharide known to have a feature of irreversibly gelatinizing under high temperatures over 80° C. Said feature leads to its widely applications in food industries as it may significantly improve the water-holding capacity, the elasticity, the stability, the thickness, and the taste of food products.

For the petroleum production, development of new profile control and water plugging agents is one of critical approaches in improving the recovery rate and the efficiency in the petroleum production. Among others, the effective period, the suitability, the costs and the feasibility are important characters to the profile control and water plugging agent s.

Under existing high-temperature profile control systems based on the curdlan gel, said systems are first dispensed in water under normal surface temperatures, before injected into water or oil wells. The systems flow to sites of actions having high temperatures and gelatinize in short periods. Said gelatinization is resistant to salinity thus the systems may be introduced as profile control plugging agents to oil productions.

However, the existing systems with the curdlan gel have their critical disadvantages in practices. When the temperature at opens of wells or transacting regions of the wells is between 65° C. to 90° C., the systems will rapid increase their viscosities to above 5,000 mpa·s, or be gelatinized into solid gels in short period, which is usually under 30 minutes, which leads to prematured formation of the solid gel that prevent the systems from being transported to deeper underground or even block subsequent transportation of the system.

Therefore, there is a need to develop a profile control and water plugging agent that is featured with delayed gelatinization under the mid- to high temperatures.

### DESCRIPTION OF DRAWINGS

FIG. 1 is a comparison of viscosity curves of profile control and water plugging agent s prepared in Embodiment 1 and its control, respectively.

FIG. 2 is a comparison of viscosity curves of profile control and water plugging agent s prepared in Embodiment 2 and its control, respectively.

FIG. 3 is a comparison of viscosity curves of profile control and water plugging agent s prepared in Embodiment 3 and its control, respectively.

FIG. 4 is a comparison of viscosity curves of profile control and water plugging agent s prepared in Embodiment 4 and its control, respectively.

FIG. 5 is a comparison of viscosity curves of profile control and water plugging agent s prepared in Embodiments 5 and its control, respectively.

FIG. 6 is a comparison of viscosity curves of profile control and water plugging agent s prepared in Embodiment 6 and its control, respectively.

### SUMMARY DESCRIPTION OF THE INVENTION

An objection of the present invention is to overcome the disadvantages of the prior art, and provide a mid-to-high heat-resistant profile control and water plugging agent applicable in petroleum production. Said agent may maintain its fluidity and its viscosity may increase slowly under mid-to-high temperatures between 65° C. and 90° C. Thus, it may satisfy needs of being transported to desired depth underground.

Yet another objection the present invention is to provide a method of preparing said agent.

In order to achieve the objections, the present invention introduced following strategies:

The mid-to-high heat-resistant profile control and water plugging agent for the petroleum production consists of a microbial polysaccharides base and a delayed gelatinization agent, wherein said microbial polysaccharides base and said delayed gelatinization agent have a ratio by weight at (5-20):(0.01-15).

Said base may be prepared by mixing curdlan gels and a hydrogen bond linkage force facilitation agent at a ratio by weight at (20-1):(1-1.5); or the curdlan gels and a coagulant aid at a ratio by weight at (2-1):(1-12).

According to one embodiment of the present invention, the hydrogen bond linkage force facilitation agent may be at least one of followed: KCl, K₃PO₄, CaCl₂, and boric acid.

According to one embodiment of the present invention, the coagulant aid may be at least one of followed: ammonium nitrate, ammonium chloride, urea, and diammonium phosphate.

According to one embodiment of the present invention, the delayed gelatinization agent may be at least one of the followed: polyalcohol, high molecular weight polymer hydrolyzed polyacrylamide, and gluconate.

Preferably, the ratio by weight between the microbial polysaccharides base and the delayed gelatinization agent is at (5-11):(0.01-5).

Preferably, the high molecular weight polymer hydrolyzed polyacrylamide is anionic hydrolyzed polyacrylamide, having a molecular weight between 12,000,000 and 36,000,000, and a hydrolysis degree at 10-60%. More preferably, said anionic hydrolyzed polyacrylamide has a hydrolysis degree at 40-50%.

The hydrolysis degree is a critical index in evaluating the performance of the anionic hydrolyzed polyacrylamide. The hydrolysis degree means the ratio between molecular numbers of a chemical that have been hydrolyzed and total molecular numbers of said chemical when a hydrolysis reaction of the chemical reaches its balance. The hydrolysis degree is associated with the dissolving speed of the anionic hydrolyzed polyacrylamide as well as its material costs. The anionic hydrolyzed polyacrylamide described in the present invention is selected from the hydrolysis degree that has a optimized range after multiple experience, while balancing the resolving speed and the material costs.

Preferably, said polyalcohol may be at least one of the following: glycerol, pentaerythritol, and diethylene glycol.

Said gluconate may be at least one of the following: sodium gluconate, potassium gluconate, and calcium gluconate. The gluconate selected by the present invention have functions of sustained release and buffering, is relatively of low cost, and is suitable for industrial applications.

The steps of the preparing method of said profile control and water plugging agent is described as the following: mixing the microbial polysaccharides base and the delayed gelatinization agent prior to dissolving the mixed into water, or mixing the two in the water during a swelling process, wherein the microbial polysaccharides base and the delayed gelatinization agent have a weight-volume ration of (5-19.5)% in a solution therefrom, which means the weight of both the microbial polysaccharides base and the delayed gelatinization agent is 5-19.5 gram per 100 ml of the solution, which is the profile control and water plugging agent. Said weight-volume ratio is important to the functionality of the profile control and water plugging agent. Choice of said ratio is unconventional as the inventors discovered it with experiences: any number higher than said ratio would lead to rapidly increase of viscosity, and high cost in producing; any number lower than said ratio, would lead to low strength of gel geletinized.

The profile control and water plugging agent of the present invention may maintain its fluidity under 65° C.˜90° C. for 4-20 hours and up; be gelatinized under 45° C.˜120° C. for 30 min to 7 days, wherein the gel from the gelatinization has the hardness of 500-900 g/cm². Comparing with prior art (700 g/cm²), the profile control and water plugging agent has similar or improved gel hardness as its hardness is not compromised due to delayed gelatinization.

When transporting the profile control and water plugging agent of the present invention to sites of actions under the wells, such as in highly-productive channels in water- or oil-wells having overly severe underground-water issues, said profile control and water plugging agent may gelatinize by heat-effects, transform from liquid to stable and solid formation, so that apply its plugging function.

According to one embodiment of the present invention, the delayed gelatinization agent may compete with the functional groups or partially block the functional sites from microbial polysaccharides under certain temperatures, thus delay or extend the process of the gelatinization. As the temperature raising higher or with sufficient energy absorbed, the functional groups and sites from the microbial polysaccharides may again form crosslinks which leads to the gelatinization.

The present invention is advantageous at:

By adding the delayed gelatinization agent, said profile control and water plugging agent of the present invention maintains a relatively stable fluidility and a low viscosity under mid-to-high temperatures (65° C.-90° C.) for 4-48 hours or longer, which ensures the profile control and water plugging agent being pumped into the underground with great depths, and prevents gelatination due to rapidly increased viscosity which causes blockage to subsequent transportion under in situ and continuous operating conditions. At the same time, the ratio has been optimized. Therefore, the hardness of the gel shows no or non-significant reduction. The present invention extends the applicable fields of the profile control and water plugging agent, improves its practicality, and reduces its operational costs.

According to one embodiment of the present invention, the profile control and water plugging agent of the present invention is based on a microbial curdlan gel, and comparing with chemical ones, said microbial based profile control and water plugging agent is more environment-friendly, less amount required, less costed, and more resistant to salty and mineral conditions.

### DESCRIPTION OF DRAWINGS

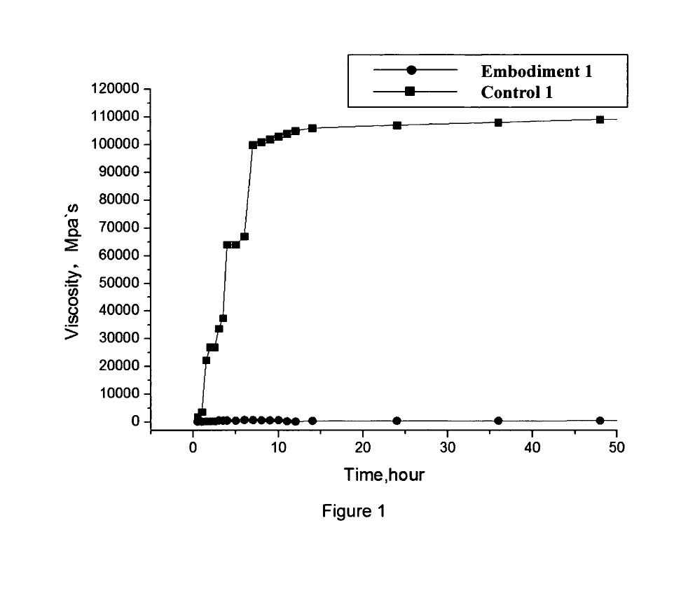

FIG. 1 is a comparison of viscosity curves of profile control and water plugging agent s prepared in Embodiment 1 and its control, respectively.

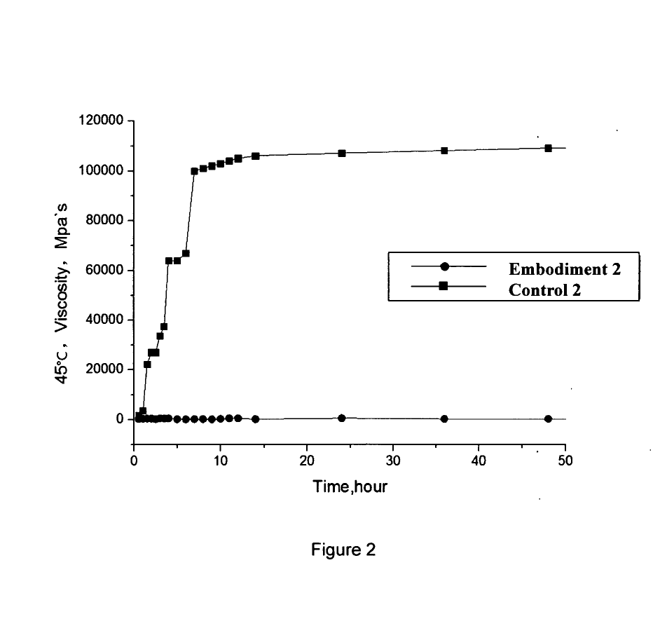

FIG. 2 is a comparison of viscosity curves of profile control and water plugging agent s prepared in Embodiment 2 and its control, respectively.

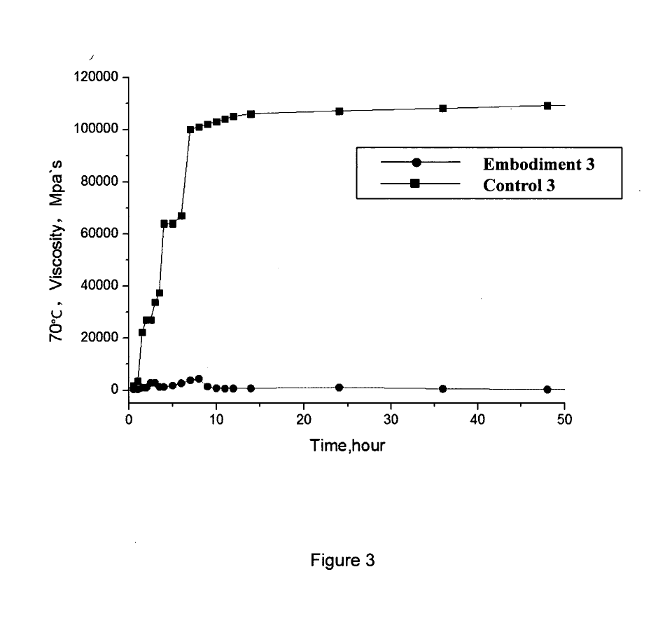

FIG. 3 is a comparison of viscosity curves of profile control and water plugging agent s prepared in Embodiment 3 and its control, respectively.

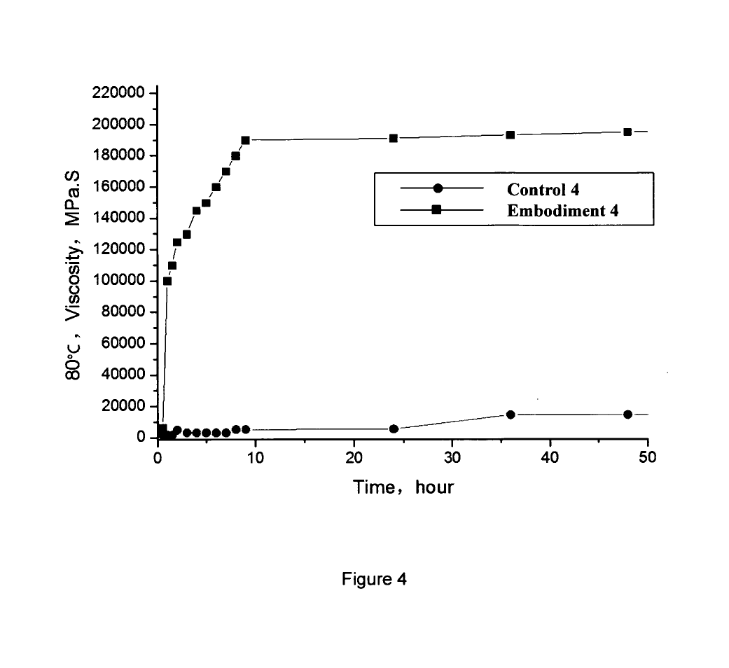

FIG. 4 is a comparison of viscosity curves of profile control and water plugging agent s prepared in Embodiment 4 and its control, respectively.

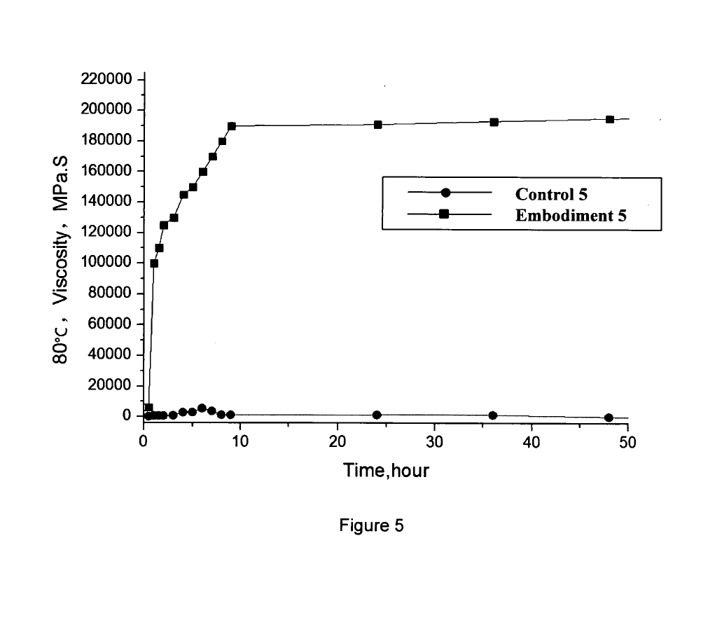

FIG. 5 is a comparison of viscosity curves of profile control and water plugging agent s prepared in Embodiments 5 and its control, respectively.

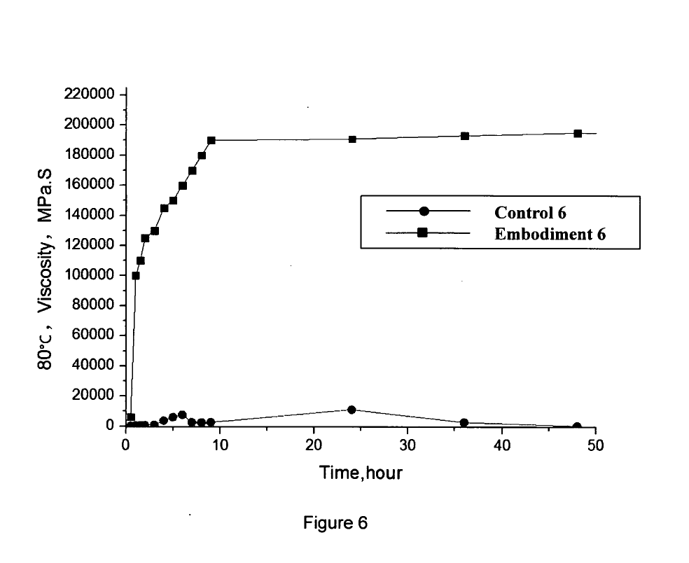

FIG. 6 is a comparison of viscosity curves of profile control and water plugging agent s prepared in Embodiment 6 and its control, respectively.

[symbol]

### DETAILED DESCRIPTION OF THE INVENTION

The present invention will be further explained by Embodiments thereof. It is to be understood that the Embodiments described herein serve as mere explanations to the present invention, and shall not be viewed as any restriction thereto.

### Embodiment 1

### 1. Preparation of a Mid-to-High Heat-Resistant Profile Control and Water Plugging Agent for a Petroleum Production

A microbial polysaccharides base and a delayed gelatinization agent were mixed at a ratio of 5:2 by weight., then dissolved by water and prepared into a solution. The solution of the base and the delayed gelatinization agent had a weight-volume ratio of 7%, which means that there was 7 gram of the base and the delayed gelatinization agent in every 100 ml solution, which was the mid-to-high heat-resistant and mineral-resistant profile control and water plugging agent applicable for the petroleum production.

Accordingly, the base was prepared by mixing curdlan gels and KCl, as a hydrogen bond linkage force facilitation agent, at the ratio of 20:1.5 by weight; and the delayed gelatinization agent was glycerol.

The profile control and water plugging agent prepared in Embodiment 1 was left at 70° C. for over 48 hours, wherein its viscosity was tested under said temperature. The result is shown in FIG. 1.

Said profile control and water plugging agent was then gelatinized under 95° C. for over 30 minutes, then its gel's strength was tested, and the result is shown in Table 1.

### 2. Application

The profile control and water plugging agent prepared in Embodiment 1 was transported into sites of actions in highly-productive channels of a operating water-well having severe underground-water issues, said agent gelatinized under high temperatures, converted from a liquid to a stable and solid form, which resulted in a sealing function.

### Control 1

Control 1 was prepared by all the same steps as to Embodiment 1 without mixing with the delayed gelatinization agent. Its viscosity at 70° C. is shown in FIG. 1 and its gel's hardness is shown in Table 1.

TABLE 1
Testing results of the hardness of gels gelatinized
from Embodiment 1 and Control 1

| Sample | Hardness (g/cm2) |
|---|---|
| Control 1 | 715.3 |
| Embodiment 1 | 653.1 |

### Embodiment 2

### 1. Preparation of the Mid-to-High Heat-Resistant Profile Control and Water Plugging Agent for the Petroleum Production

The microbial polysaccharides base and the delayed gelatinization agent were mixed at the ratio of 11:0.1 by weight., then dissolved by water and prepared into the solution. The solution of the base and the delayed gelatinization agent had the weight-volume ratio of 11.1% which was the mid-to-high heat-resistant and mineral-resistant profile control and water plugging agent applicable in the petroleum production.

Accordingly, the base was prepared by mixing the curdlen gels and ammonium nitrate as a coagulant aid, at 2:1 by weight and the delayed gelatinization agent was hydrolyzed polyacrylamide having a molecular weight of 12,000,000 and a hydrolysis degree of 40%.

The profile control and water plugging agent prepared in Embodiment 2 was left at 45° C. for over 48 hours, wherein its viscosity was tested under said temperature. The result is shown in FIG. 2.

Said profile control and water plugging agent was then gelatinized under 45° C. for over 7 days, then its gel's hardness was tested, and the result is shown in Table 2.

### 2. Application

The application of the profile control and water plugging agent prepared in Embodiment 2 was the same as that from Embodiment 1.

### Control 2

Control 2 was prepared by all the same steps as to Embodiment 2 without mixing with the delayed gelatinization agent. Its viscosity at 45° C. is shown in FIG. 2 and its gel's hardness is shown in Table 2.

TABLE 2
Testing results of the hardness of gels gelatinized
from Embodiment 2 and Control 2

| Sample | Hardness (g/cm2) |
|---|---|
| Control 2 | 721.4 |
| Embodiment 2 | 632.1 |

### Embodiment 3

### 1. Preparation of the Mid-to-High Heat-Resistant Profile Control and Water Plugging Agent for the Petroleum Production

The microbial polysaccharides base and the delayed gelatinization agent were mixed at the ratio of 6.5:0.01 by weight., then dissolved by water and prepared into the solution. The solution of the base and the delayed gelatinization agent had the weight-volume ratio of 6.51%, which was the mid-to-high heat-resistant and mineral-resistant profile control and water plugging agent applicable in the petroleum production.

Accordingly, the base was prepared by mixing the curdlen gels and KCl as the hydrogen bond linkage force facilitation agent, at the ratio of 10:1 by weight and the delayed gelatinization agent was the hydrolyzed polyacrylamide having its molecular weight of 36,000,000 and its hydrolysis degree of 50%.

The profile control and water plugging agent prepared in Embodiment 3 was left at 70° C. for over 48 hours, wherein its viscosity was tested under said temperature. The result is shown in FIG. 3.

Said profile control and water plugging agent was then gelatinized under 70° C. for over 7 days, then its gel's hardness was tested, and the result is shown in Table 3.

### 2. Application

The profile control and water plugging agent prepared in Embodiment 3 was transported into sites of actions in the highly-productive channels of the operating water well having the severe underground-water issues.

### Control 3

Control 3 was prepared by all the same steps as to Embodiment 3 without mixing the delayed gelatinization agent. Its viscosity at 70° C. was shown in FIG. 3 and its gel's hardness is shown in Table 3.

TABLE 3
Testing results of the hardness of gels gelatinized
from Embodiment 3 and Control 3

| Sample | Hardness (g/cm2) |
|---|---|
| Control 3 | 831.6 |
| Embodiment 3 | 891.3 |

### Embodiment 4

### 1. Preparation of the Mid-to-High Heat-Resistant Profile Control and Water Plugging Agent for the Petroleum Production

The microbial polysaccharides base and the delayed gelatinization agent were mixed at the ratio of 6.5:0.1 by weight., then dissolved by water and prepared into the solution. The solution of the base and the delayed gelatinization agent had the weight-volume ratio of 6.6%, which was the mid-to-high heat-resistant and mineral-resistant profile control and water plugging agent applicable in the petroleum production.

Accordingly, the base was prepared by mixing the curdlen gels and KCl as the hydrogen bond linkage force facilitation agent, at 10:1 by weight and the delayed gelatinization agent was the hydrolyzed polyacrylamide having its molecular weight of 36,000,000 and its hydrolysis degree of 50%.

The profile control and water plugging agent prepared in Embodiment 4 was left at 80° C. for over 48 hours, wherein its viscosity was tested under said temperature. The result is shown in FIG. 4.

Said profile control and water plugging agent was then gelatinized under 80° C. for over 7 days, then its gel's hardness was tested, and the result is shown in Table 4.

### 2. Application

The application of the profile control and water plugging agent prepared in Embodiment 4 was the same as that from Embodiment 3.

### Control 4

Control 4 was prepared by all the same steps as to Embodiment 4 without mixing with the delayed gelatinization agent. Its viscosity at 80° C. is shown in FIG. 4 and its gel's hardness is shown in Table 4.

TABLE 4
Testing results of the hardness of gels gelatinized
from Embodiment 4 and Control 4

| Sample | Hardness (g/cm2) |
|---|---|
| Control 4 | 731.1 |
| Embodiment 4 | 662.8 |

### Embodiment 5

### 1. Preparation of the Mid-to-High Heat-Resistant Profile Control and Water Plugging Agent for the Petroleum Production

The microbial polysaccharides base and the delayed gelatinization agent were mixed at the ratio of 6.5:2 by weight., then dissolved by water and prepared into the solution. The solution of the base and the delayed gelatinization agent had the weight-volume ratio of 8.5%, which was the mid-to-high heat-resistant and mineral-resistant profile control and water plugging agent applicable for the petroleum production.

Accordingly, the base was prepared by mixing the curdlan gels and K₃PO₄ as the hydrogen bond linkage force facilitation agent, at the ratio of 10:1 by weight; and the delayed gelatinization agent was sodium gluconate.

The profile control and water plugging agent prepared in Embodiment 5 was left at 80° C. for over 48 hours, wherein its viscosity was tested under said temperature. The result is shown in FIG. 5.

Said profile control and water plugging agent was then gelatinized under 95° C. for over 7 days, then its gel's hardness was tested, and the result is shown in Table 5.

### 2. Application

The application of the profile control and water plugging agent prepared in Embodiment 5 was the same as that from Embodiment 1.

### Control 5

Control 5 was prepared by all the same steps as to Embodiment 5 without mixing with the delayed gelatinization agent. Its viscosity at 70° C. is shown in FIG. 5 and its gel's hardness is shown in Table 5.

TABLE 5
Testing results of the hardness of gels gelatinized
from Embodiment 5 and Control 5

| Sample | Hardness (g/cm2) |
|---|---|
| Control 5 | 834.9 |
| Embodiment 5 | 879.1 |

### Embodiment 6

### 1. Preparation of the Mid-to-High Heat-Resistant Profile Control and Water Plugging Agent for the Petroleum Production

The microbial polysaccharides base and the delayed gelatinization agent were mixed at the ratio of 11:5 by weight., then dissolved by water and prepared into the solution. The solution of the base and the delayed gelatinization agent had a weight-volume ratio of 9.6%, which was the mid-to-high heat-resistant and mineral-resistant profile control and water plugging agent applicable for the petroleum production.

Accordingly, the base was prepared by mixing curdlan gels and KCL as the hydrogen bond linkage force facilitation agent, at the ratio of 10:1 by weight; and the delayed gelatinization agent was Potassium gluconate.

The profile control and water plugging agent prepared in Embodiment 6 was left at 80° C. for over 48 hours, wherein its viscosity was tested under said temperature. The result is shown in FIG. 6.

Said profile control and water plugging agent was then gelatinized under 95° C. for over 7 days, then its gel's hardness was tested, and the result is shown in Table 6.

### 2. Application

The application of the profile control and water plugging agent prepared in Embodiment 6 was the same as that from Embodiment 1.

### Control 6

Control 6 was prepared by all the same steps as to Embodiment 6 without mixing the delayed gelatinization agent. Its viscosity at 70° C. is shown in FIG. 6 and its gel's hardness is shown in Table 6.

TABLE 4
Testing results of the hardness of gels gelatinized
from Embodiment 6 and Control 6

| Sample | Hardness (g/cm2) |
|---|---|
| Control 6 | 768.3 |
| Embodiment 6 | 797.96 |

The Embodiments and Controls aforementioned suggest that: with the presence of the delayed gelatinization agent in the profile control and water plugging agent of the present invention, its products may maintain relatively stabled fluidity and relatively low viscosity under the mid-to-high temperature condition (65° C.˜90° C.), so that ensures said products may be pumped into lower grounds during continuous in situ operatings, without unability of subsequent injections of the products at late stages of the operatings due to rapidly increased viscosity. Comparing with prior art, its gel's strength is not significantly compromised, and it achieves great plugging function at sites of the actions.

We claim:

1. A mid-to-high heat-resistant profile control and water plugging agent for petroleum production, comprising: a microbial polysaccharides base and a delayed gelatinization agent, wherein said microbial polysaccharides base and said delayed gelatinization agent are mixed at a ratio by weight at (5-20):(0.01-15); and, said delayed gelatinization agent may be selected from at least one of the following: polyalcohol, high molecular weight polymer hydrolyzed polyacrylamide, and gluconate, wherein the high molecular weight polymer hydrolyzed polyacrylamide is hydrolyzed polyacrylamide having a molecular weight between 12,000,000 and 36,000,000, and a hydrolysis degree between 10% and 60%.

2. The profile control and water plugging agent from claim 1, wherein said polyalcohol may be at least one of the following: glycerol, pentaerythritol, and diethylene glycol; said gluconate may be at least one of the following: sodium gluconate, potassium gluconate, and calcium gluconate.

3. The profile control and water plugging agent from claim 1, wherein said high molecular weight polymer hydrolyzed polyacrylamide is Anionic hydrolyzed polyacrylamide having its hydrolysis degree between 40-50%.

4. The profile control and water plugging agent from claim 1, wherein said ratio by weight of said microbial polysaccharides base and said delayed gelatinization agent is (5-11):(0.01-5).

5. The profile control and water plugging agent from claim 1, wherein said microbial polysaccharides base comprises curdlan gels and a hydrogen bond linkage force facilitation agent mixed at a ratio by weight of (20-1):(1-1.5); or the curdlan gels and a coagulant aid mixed at a ratio by weight of (2-1):(1-12); wherein said hydrogen bond linkage force facilitation agent may beat least one of followed: KCL, K₃PO₄, CaCl, and boric acid, and said coagulant aids may be at least one of followed: ammonium nitrate, ammonium chloride, urea, and diammonium phosphate.

6. The profile control and water plugging agent from claim 1, wherein said microbial polysaccharides base and said delayed gelatinization agent are mixed at the ratio by weight at 5:2; said microbial polysaccharides base is prepared by the curdlan gels and KCL mixed at the ratio by weight at 20:1.5; said delayed gelatinization agent is the glycerol.

7. The profile control and water plugging agent from claim 1, wherein said microbial polysaccharides base and said delayed gelatinization agent are mixed at the ratio by weight at 11:0.1; said microbial polysaccharides base is prepared by the curdlan gels and ammonium nitrate mixed at the ratio by weight at 2:1; said delayed gelatinization agent is Anionic hydrolyzed polyacrylamide having its molecular weight of 12,000,000 and its hydrolysis degree of 40%.

8. The profile control and water plugging agent from claim 1, wherein said microbial polysaccharides base and said delayed gelatinization agent are mixed at the ratio by weight at 6.5:0.01; said microbial polysaccharides base is prepared by the curdlan gels and KCL mixed at the ratio by weight at 10:1; said delayed gelatinization agent is Anionic hydrolyzed polyacrylamide having its molecular weight of 36,000,000 and its hydrolysis degree of 50%.

9. The profile control and water plugging agent from any of claims 1-8, further comprising a preparation method: mixing said microbial polysaccharides base and said delayed gelatinization agent and dissolving the mixed in the water; or, mixing said microbial polysaccharides base and said delayed gelatinization agent in the water during a swelling process; wherein said microbial polysaccharides base and said delayed gelatinization agent have a weight-volume ratio of 5-19.5% in a solution which is the profile control and water plugging agent.

10. The profile control and water plugging agent from any of claims 1-8, wherein its method of sealing and profile control comprising: transporting said profile control and water plugging agent to sites of actions, wherein the sealing and the profile control are requested; gelatinizing under a temperature; converting its formation from liquid to solid; and, sealing.
